(19) United States
(12) Patent Application Publication
(10) Pub. No.: US 2011/0267196 A1
(43) Pub. Date: Nov. 3, 2011

(54) SYSTEM AND METHOD FOR PROVIDING SLEEP QUALITY FEEDBACK

(76) Inventors: Julia Hu, Menlo Park, CA (US); Alvin Lacson, Palo Alto, CA (US)

(21) Appl. No.: 13/100,104

(22) Filed: May 3, 2011

Related U.S. Application Data
(60) Provisional application No. 61/330,788, filed on May 3, 2010.

(51) Int. Cl. G08B 23/00

(52) U.S. Cl. 340/575

(57) ABSTRACT

A system and method for providing sleep quality feedback that includes receiving alarm input on a base device from a user; the base device communicating an alarm setting based on the alarm input to an individual sleep device; the individual sleep device collecting sleep data based on activity input of a user; the individual sleep device communicating sleep data to the base device; the base device calculating sleep quality feedback from the sleep data; communicating sleep quality feedback to a user; and the individual sleep device activating an alarm, wherein activating the alarm includes generating tactile feedback to the user according to the alarm setting.

### CROSS-REFERENCE TO RELATED APPLICATIONS

This application claims the benefit of U.S. Provisional Application No. 61/330,788, filed May 3, 2010 and entitled “SYSTEM AND METHOD FOR WAKING AN INDIVIDUAL WITH A TARGETED ALARM”, which is incorporated in its entirety by this reference.

### TECHNICAL FIELD

This invention relates generally to the wearable sensor device field, and more specifically to a new and useful system and method for providing sleep quality feedback in the digital alarm field.

### BACKGROUND

Sleep is as important as breathing, water, and food. We spend much time and money to ensure that we breathe purified air, filtered water, and organically grown food, but—except for a decent mattress and pillow—we rarely any time or money to ensure that we sleep well. Traditional sleep quality feedback systems are made available in a sleep clinic setting which is often expensive, not necessarily a good reproduction of one's own bed, and only a small sample size of the sleep quality for a person. Thus, there is a need in the wearable sensor device field to create a new and useful system and method for providing sleep quality feedback. This invention provides such system and method.

### BRIEF DESCRIPTION OF THE FIGURES

FIG. 1 is a schematic representation of a preferred embodiment of the invention;

FIG. 2 is a detailed schematic representation of a base alarm device of a preferred embodiment of the invention;

FIG. 3 is a detailed schematic representation of a individual alarm device of a preferred embodiment of the invention;

FIG. 4 is a schematic representation of a method of a preferred embodiment of the invention;

FIGS. 5A and 5B are detailed schematic representations of a method of a preferred embodiment of the invention;

FIG. 6 is a schematic representation of a variation with a plurality of individual sleep devices in a method of a preferred embodiment;

FIG. 7 is a schematic representation of a variation communicating with a central sleep service platform of a preferred embodiment of the invention; and

FIG. 8 is a schematic representation of a variation with environmental condition masking in a method of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### System for Providing Sleep Quality Feedback

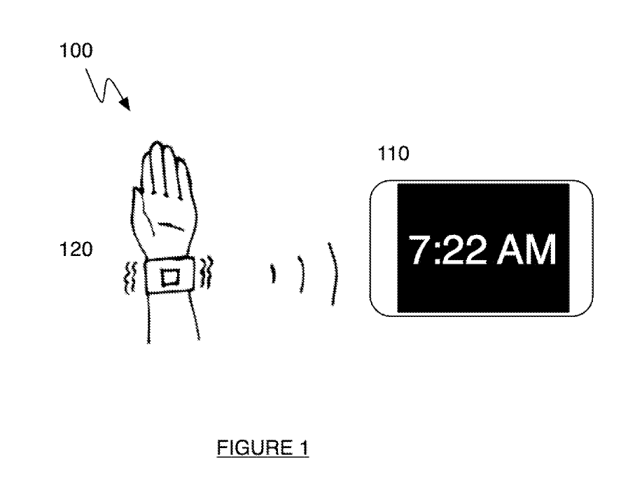

As shown in FIG. 1, a system 100 of a preferred embodiment includes a base device 110 with a wireless communication component 112, and an individual sleep device 120 with a wireless communication component 122, a targeted alarm 124, and a sleep pattern sensor 126. The system 100 functions to monitor the sleep cycle of an individual and provide sleep feedback. The sleep feedback may be through infographic representation of sleep quality of a user throughout a night or alternatively by determining the timing of a targeted alarm disturbance. The sleep feedback may alternatively be used in any suitable application. The system preferably distributes components of a sleep quality analysis system such that the benefits of sleep cycle analyses can be combined with targeted alarm. Such a system can be used to improve the quality of sleep. Sleep cycle analysis can be used to provide feedback to a user, and to promote improved sleep quality. A targeted alarm preferably will wake an individual from sleep without disturbing other people sleeping in the vicinity, and additionally the targeted alarm wakes a user in a non-abrupt or non jarring fashion. As another benefit of distributing the components of the system, the individual sleep device can preferably be designed for ergonomic comfort without structural limitations that may come from technical requirements. The system is preferably implemented with a mobile device such as a smart phone as the base device 110 and a lightweight wristband with a vibrating targeted alarm 124. However, the base device and individual sleep device may alternatively come in any suitable form. The system may additionally include a plurality of individual sleep devices 120 that are in communication with the base device to awaken a plurality of individuals.

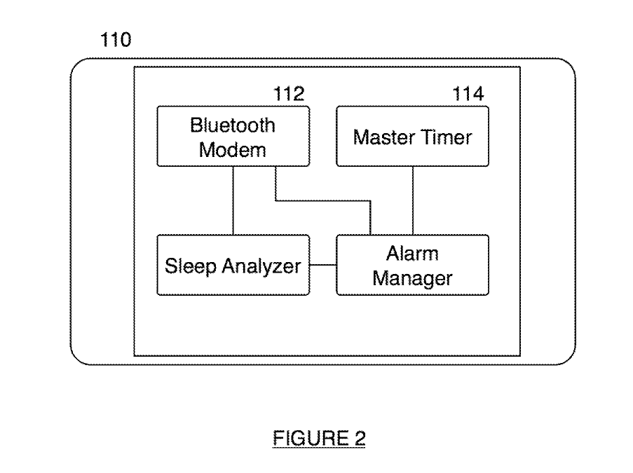

As shown in FIG. 2, the base device 110 functions to house the main processing and interface components of the system 100. The base device 110 is preferably an application running on a mobile phone but may be any suitable device such as a desktop or laptop computer, a tablet or mobile computer, a standalone alarm clock (with additional components for communication and sleep cycle analysis described below), or any suitable electronic device or software application. The base device no preferably includes a user interface for settings the alarm, setting (or “hitting”) a snooze alarm, setting the time, and performing any suitable user input with the system 100. The user interface preferably includes physical inputs such as buttons or switches as well as touch surfaces and graphical user interfaces presented on the base device no. The base device 110 preferably is used as a traditional alarm that is typically placed somewhere in the room where the individual is sleeping. Additionally, user deactivation of an alarm is preferably performed through the base device no. The base device 110 preferably is powered through an electrical outlet or other charging source while the individual is sleeping. The base device 110 may alternatively operate on battery power or any suitable power source. The base device preferably includes a master timer 114. The master timer is preferably a clock used as the main clock reference. The master timer is preferably a clock maintained by the device, such a mobile phone, which may be updated by an outside source. The base device 110 preferably stores sleep cycle data, and includes the program information to process the data for sleep cycle analysis. The data may alternatively be stored remotely such as on a remote server. The base device no preferably handles sleep cycle processing with a sleep analysis engine. The sleep analysis engine preferably calculates sleep quality feedback, which is used to control feedback to the user based on the quality of sleep. The sleep analysis engine preferably alleviates the individual sleep device 120 of this relatively complex processing. The sleep cycle analysis is preferably performed on the sleep cycle data to determine various parameters of sleep patterns of an individual, including: sleep quality, wake up times during the middle of the night (conscious and unconscious), time of falling asleep, wake up time, amount of sleep, sleep cycles, and/or any parameter of sleep. The analysis is preferably performed on the sleep cycle data currently being collected but may additionally include analysis of past data, global sleep data from other users, and/or any suitable data sources. The sleep history may be used to adapt the analysis of the data based on past sleep patterns of an individual (e.g., if the individual is a deep sleeper vs. a light sleeper). The sleep cycle analysis can preferably learn over time to optimize the sleep patterns of an individual. In one variation, the sleep quality feedback calculated by the analysis engine is presented to a user graphically through a display on the base device. The user can preferably use the feedback of the data to take action to improve sleep quality of the user. The sleep analysis may alternatively be used for determining an optimum time to activate the targeted alarm 124 of the individual sleep device 120, but the analysis may alternatively be used for medical monitoring, personal feedback, or any suitable application.

The wireless communication components 112 and 122 of the base device 110 and individual sleep device 120, respectively, function to allow for synchronization and data transfer to occur between the base device 110 and the individual sleep device 120. The wireless communication components preferably communicate using a short-range communication protocol, but any suitable form of communication may be used. The wireless communication components 112 and 122 are preferably Bluetooth modems that are commonly included with mobile phones and personal computers, but the wireless communication components 112 and 122 may be Zigbee, Wi-Fi internet, infrared (IR) communication, radio frequency (RF) communication, ultrasound, or any suitable communication protocol. The wireless communication components 112 and 122 are preferably periodically used for communication while an individual sleeps as a means to conserve battery life. As the time approaches for the individual to be awakened, the wireless communication components 112 and 122 preferably communicate more frequently. In one example, prior to the time of a set alarm, data is transferred from the individual sleep device 120 to the base device 110. Periodic bursts of communication preferably allow the individual sleep device 120 to conserve battery life, which places less technical restrictions on the battery of the individual sleep device 120. The communication components 112 and 122 additionally are preferably used to communicate user input, which preferably alleviates the individual sleep device 120 from including buttons, switches, or user interface components.

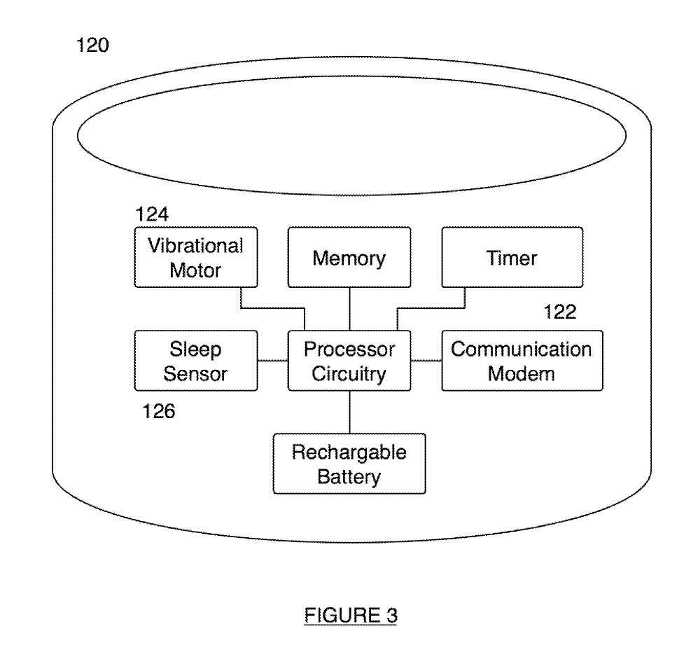

As shown in FIG. 3, the individual sleep device 120 functions to collect data on the sleep quality of an individual and awaken the individual with a targeted alarm. The individual sleep device 120 is preferably able to detect the sleep patterns of an individual sleeper and awaken an individual without waking another person sleeping in the same room or bed. The individual sleep device 120 is preferably a lightweight wristband, but the individual sleep device 120 may alternatively be a pillow, a blanket, a mattress, article of clothing, jewelry, a stuffed animal, or any suitable object. The data processing, outside communication, user input, and other features are preferably distributed to the base alarm device no so that the design of the individual sleep device can be optimized for ergonomics and comfort. The individual sleep device 120 preferably has no display or user input mechanisms to reduce the technical requirements of the device, which may enhance the battery life and the comfort level of a wristband individual sleep device 120. The individual sleep device preferably has physical contact with the individual such that the target alarm 124 will only awaken the intended individual from sleep. The targeted alarm 124 is preferably a tactile based alarm and more preferably a vibrational alarm using a vibrating motor, a piezoelectric vibrator, and/or any suitable system to stimulate the sense of touch of the individual. The targeted alarm 124 may alternatively be temperature based, a focused sound (such as an isolated sound beam or a speaker inserted into the ear, like a hearing aid), or any suitable device to disturb the sleep of a single individual. The vibrating targeted alarm 124 is preferably positioned to rest on the underside of the wrist of the individual but any suitable location may alternatively be used. The housing (e.g., a strap or bracelet body) of the individual sleep device 120 preferably couples the targeted alarm to the user. The pattern of activation of the targeted alarm 124 may additionally be controlled to avoid a jarring wakeup experience while still effectively waking an individual. The targeted alarm preferably generates a random signal that has a Poisson distribution. In one preferred variation, the signal is translated into vibration of the targeted alarm 124. The pattern is preferably repeated several times within a single alarm, but between different alarms (e.g., the next morning) the pattern is changed. The signal preferably creates short vibration pulses and has a skewed bell curve (e.g., Poisson distribution). Preferably, the pulses are on average shorter than the area of non-pulse. The signal of the targeted alarm may alternatively have any suitable pattern. Additionally, a second alarm (such as an audio alarm) may be included. The second alarm is preferably more jarring than the targeted alarm either in amplitude, medium of alarming such as audio, vibration, light, or any suitable medium through which an alarm may awaken a user. The second alarm is preferably triggered after a fixed period of time after the targeted alarm was triggered, which functions as a backup. As mentioned above, a plurality of individual sleep devices 120 may be used with a plurality of users and be managed by an individual base device no.

The individual sleep device 120 of the preferred embodiment additionally includes a sleep pattern sensor 126, which functions to collect sleep data for analyzing a sleep cycle. The sleep pattern sensor 126 is preferably any suitable sensor, such as an actigraphy sensor, that can sense parameters associated with sleep patterns of an individual. In one variation, a motion sensor is preferably used to measure the motion of the sleeper using a vibrational switch, accelerometer, gyroscope, and/or any suitable motion sensor. In another variation, a body-electrical sensor preferably measures electrical activity of a body system such as an electroencephalography (EEG) or an electrocardiography (EKG). Any suitable sensor may alternatively be used. The individual sleep device preferably includes a processor (i.e., conditioning engine) that analyzes and preferably simplifies the data. The sensors preferably collect raw activity input from a user. The processor preferably performs a high pass filter, a low pass filter, and calculates a moving average on the activity input signal. This may be used to calculate a sleep quality datapoint to represent the quality of sleep for a period of time (e.g., quality of sleep for 30 second duration). The sleep quality datapoint functions to reduce the amount and complexity of sleep data communicated between the individual sleep device 120 and the base device 110.

The individual sleep device 120 of the preferred embodiment additionally includes data memory that preferably stores sleep cycle data in between communications with the base alarm device 110. The data memory is preferably DRAM, flash memory, electrically erasable programmable read-only memory (EEPROM), or any suitable data storage component. The data memory is preferably cleared once the data has been transferred to the base alarm device 110, but may be managed in any suitable manner.

The individual sleep device 120 of the preferred embodiment additionally includes a timer that functions to maintain the current time. This is preferably used when communication is disrupted with the base alarm device 120 (such as if the base alarm device has depleted batteries or has been moved out of communication range). The individual sleep device 120 can preferably still activate the targeted alarm 124 without the base alarm device, though the alarm may not have the benefit of analyzed sleep data. The timer is preferably updated and synchronized with the master time of the base alarm device no. An alarm setting is preferably stored on the individual sleep device 120, wherein the alarm will trigger at the appropriate timer time.

The individual sleep device 120 of the preferred embodiment additionally includes a battery. The battery is preferably embedded within the individual sleep device 120. The battery is preferably a rechargeable battery. The rechargeable battery can preferably recharged through any suitable system such as a micro universal serial bus (USB), through an audio plug, or an inductive charge. The battery may alternatively be a replaceable battery such as a button cell battery. The battery may additionally be a flexible battery.

Additionally the system may include a central sleep service platform 130, which functions as a networked central platform for storing and providing analysis of data. The central sleep service platform is preferably a server or a server platform hosted on the internet, and more preferably is remote shared computing resource. The base station no preferably uploads sleep data to the central sleep service platform 130, and the central sleep service platform 130 may communicate additional sleep quality feedback for communicating to the user, or parameters for other forms of feedback. The central sleep service preferably receives sleep quality data from a plurality of users. The central sleep service platform 130 may use all the data from the users to provide other processing features.

### Method for Providing Sleep Feedback

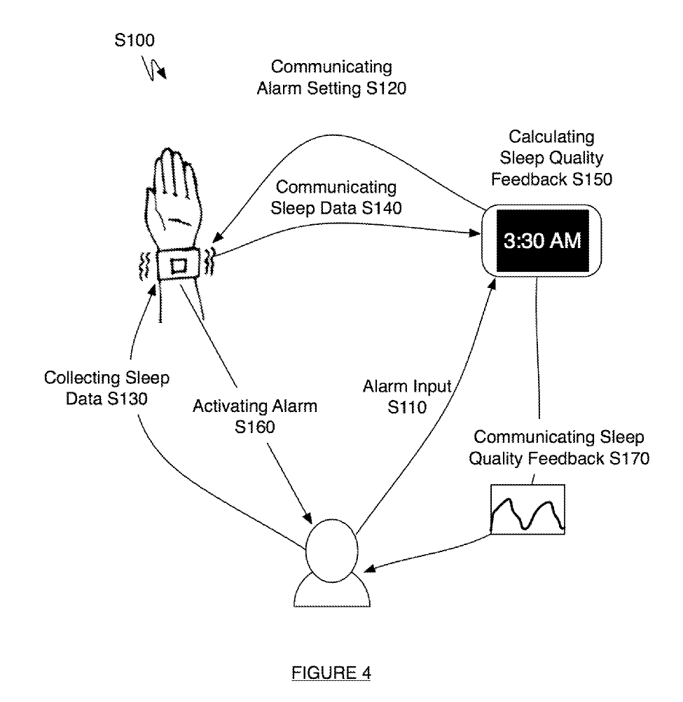

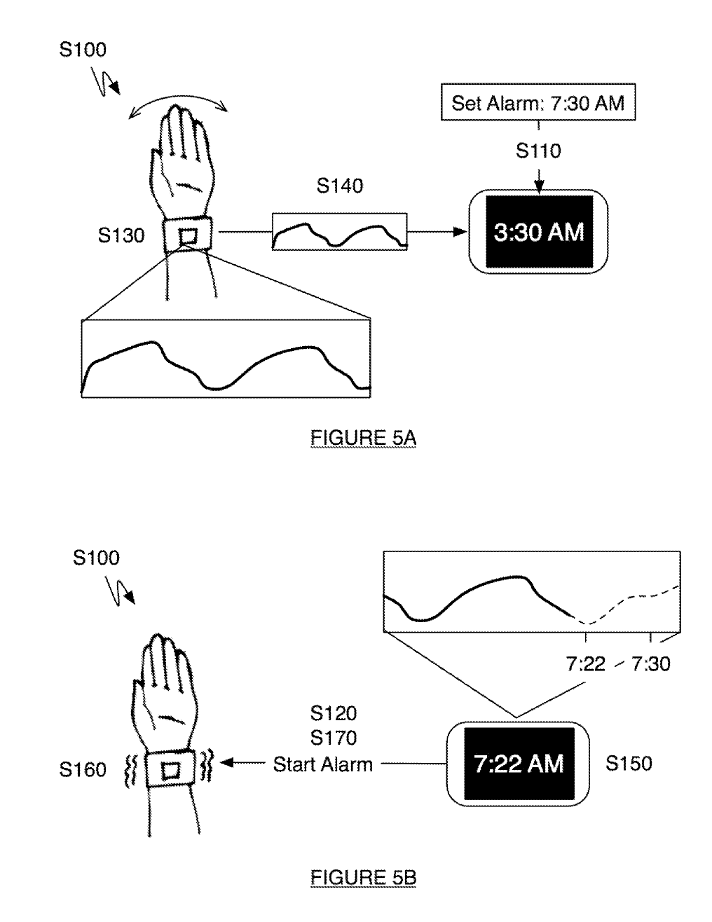

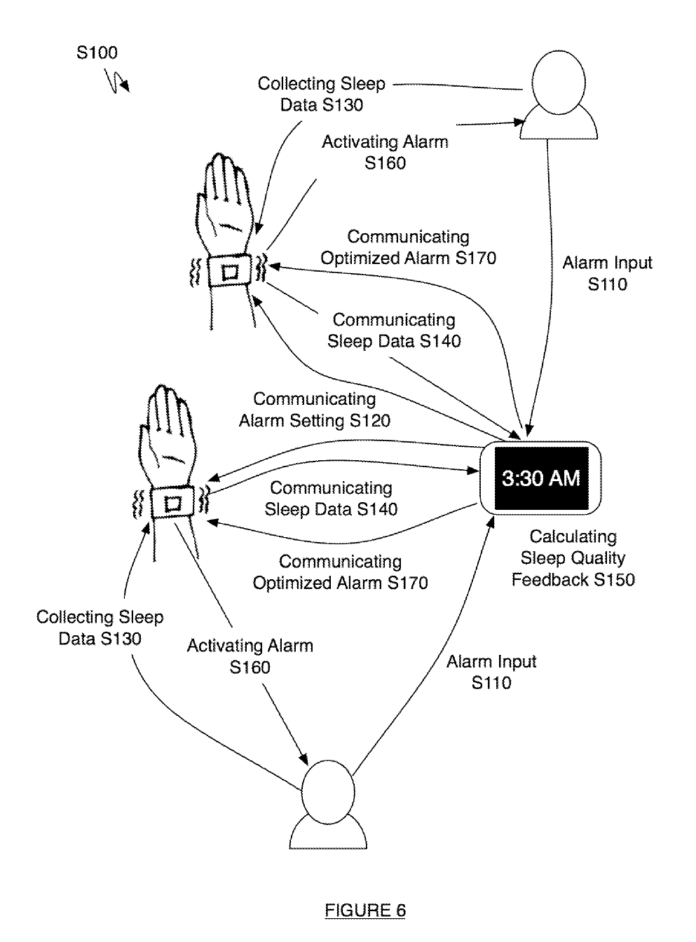

As shown in FIG. 4, a method S100 for providing sleep feedback of a preferred embodiment includes the steps of receiving alarm input on a base device from a user S110, communicating an alarm setting based on the alarm input to an individual sleep device S120, collecting sleep data based on physical activity input of a user S130, communicating sleep data to the base device S140, calculating sleep quality feedback from the sleep data S150, activating an alarm S160, and communicating sleep quality feedback to the user S170. The system functions to provide sleep quality feedback to a user and additionally to preferably waken an individual in a non-jarring manner. The sleep quality feedback is preferably used to provide information to a user, empowering the user to take action. The sleep quality feedback may alternatively be used to wake a user according to sleep patterns, to adjust the collection of user activity input and/or to be used in any suitable manner. The non jarring waking of a user preferably utilizes randomly generated signals to a targeted alarm, which functions to increase effectiveness of waking a user while preferably minimizing the magnitude of the signal (i.e., minimizing how jarring the alarm is to the user). As an exemplary application of the method, the user may set an alarm on a smart phone. The smart phone then communicates with an individual sleep device, which measures the users motion while sleeping. The individual sleep device vibrates to wake the user, and the user waking up, the smart phone displays graphics to communicate the sleep quality to the user. As a second exemplary application of the method as shown in FIGS. 5A and 5B, an individual preferably sets an approximate alarm time for when they wish to wake up. The individual is then preferably woken up near that time when the sleep cycle data indicates an optimal sleep state for being awakened (i.e., what alarm time will result in the individual feeling more rested). The method may additionally be applied to a plurality of users each using a targeted alarm as shown in FIG. 6, or the method may be adapted for any suitable application.

Step S110, which includes receiving alarm input on a base device from a user, functions to obtain from a user an alarm time. The base device preferably includes input devices such as a button, switches, touch screen, or any suitable input component for the user to set an alarm time. Using the base device to set the alarm preferably alleviates the individual sleep device from including the input mechanisms to set the time. The alarm time is preferably received, but alternative inputs may be received based on the application. For example, an earliest alarm time or a latest alarm time may be set which sets a window in which a user would likes to wake up. The inputs of the base device may additionally be used to control other aspects such as turning on environmental noise cancelation as described below.

Step S120, which includes communicating an alarm setting based on the alarm input to an individual sleep device, functions to transfer the user alarm input to the individual sleep device. Preferably, the base device will transfer the alarm setting to the individual sleep device at a suitable time after receiving the input. After receiving the alarm setting, the individual sleep device preferably sets an internal alarm. The internal alarm of the individual sleep device will preferably then determine when the alarm will be activated. Alternatively, the base device may send an alarm command, which will initiate the alarm activation. In this variation, the individual sleep device may not need to include an internal alarm, though one may be used as a backup alarm. Once the alarm command is received the individual sleep device will then activate the alarm according to the command. This variation may be useful when having a dynamic sleep alarm based on the current sleep data of a user.

Step S130, which includes collecting sleep data based on activity input of a user, functions to collect data while a person sleeps. The sleep data is preferably used to measure various parameters of sleep patterns of an individual. Sleep quality, wake up times during the middle of the night (conscious and unconscious), time of falling asleep, wake up time, amount of sleep, sleep cycles, and/or any parameter of sleep can preferably collected. Step S130 is preferably performed by a device substantially similar to the individual alarm device described above, but may alternatively be performed by any suitable device. In one variation, measuring sleep data preferably includes sensing motion of the sleeper using a vibrational switch, accelerometer, gyroscope, and/or any suitable motion sensor. In another variation, the measuring of sleep data preferably includes recording electrical activity of a body system such as an electroencephalography (EEG) or an electrocardiography (EKG). Other parameters such as temperature, ambient light, sound levels, skin resistance or any suitable parameter may alternatively be sensed. The data may additionally be supplemented with data collected by the base device or any suitable device. Such additional data may include sensing ambient sound levels, light levels, temperature, or any suitable parameter. Such additional data is preferably used in cancelling environmental conditions as described below. Step S130 may additionally include conditioning measured activity input. In one variation, the data is preferably band-pass filtered to target 0.5 Hz to 3 Hz signals. In another variation, the data is high pass filtered, low pass filtered, and then a moving average filter is applied. Then a sleep quality datapoint is preferably generated summarizing at least 30 seconds of activity. The sleep quality datapoint is preferably a value summarizing the amount of activity and functions to reduce the complexity of the data. The sleep quality datapoints are preferably consecutively generated for an entire night or any suitable duration. The conditioning of the signal may depend on conditioning parameters. The conditioning parameters may additionally depend on sleep quality feedback from the base device and/or from a central sleep service platform. The sleep data is preferably communicated to the base device during Step S140 for processing and possibly long-term storage. The sleep data may alternatively be temporarily stored on the individual sleep device for periods when the individual sleep device and base device are not in communication.

Step S140, which includes communicating activity input to the base device, functions to transfer data between the base device and the individual sleep device. The base device and individual sleep device preferably use Bluetooth (as is commonly used with mobile phones and computers), but Zigbee, Wi-Fi internet, infrared (IR) communication, ultrasound, or any suitable communication protocol may alternatively be used. The sleep data collected by the individual sleep device is preferably transferred to the base device. Step S140 may additionally include communicating between the individual sleep device and the base device on a periodic basis. This is preferably performed while the individual is asleep. The individual sleep device preferably stores the sleep data temporarily and communicates the sleep data to the base device at appropriate times. Preferably, the individual sleep device stores nearly a full nights worth of sleep data and according to the alarm setting transfers the sleep metric data to the base device. The sleep metric data is preferably transferred an hour to thirty minutes before an alarm. Sending the data prior to an alarm preferably provides time for the base device to complete calculations of sleep quality feedback. Alternatively, after a set amount of time or alternatively after receiving an initial message/ping a communication transfer will occur. All sleep data collected since the last communication is preferably sent to the base device at this time. This periodic communication preferably enables the two devices to conserve battery life, as opposed to constant communication. The timing of the communication is preferably synchronized and scheduled by timers running on the individual sleep device and the base device. The timing of the communication may additionally be dynamic. For example, when the time for the alarm is several hours away, the communications may occur a few times every hour, and when the alarm time is within the hour the communications may occur every minute.

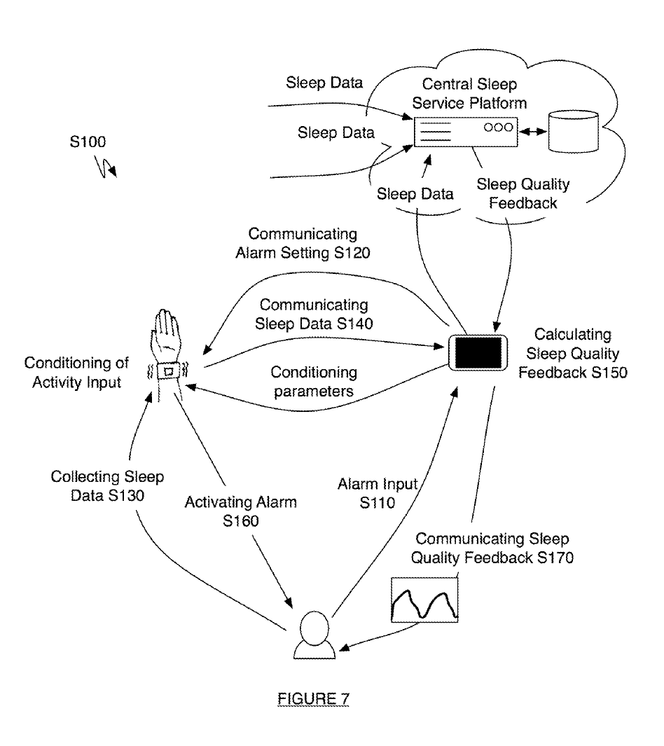

Step S150, which includes calculating sleep quality feedback from the sleep data, functions to analyze the sleep data to generate a form of feedback that can help improve the sleep of a user. In a first preferred variation, the calculation is an analysis of sleep patterns to create graphical feedback. The base device preferably creates graphs, charts, ratings, textual descriptions, and/or any media description of a night of sleep for the user. This graphical feedback is preferably presented to the user after waking on the display of the base device, and the user can preferably use the information to take appropriate action. In a second preferred variation, the calculation identifies an optimal time to wake an individual. Through analysis of the data collected in Step S130, the current sleep cycle may be determined. This is preferably used to determine when an alarm should be activated. The alarm is preferably activated when an individual is at the end of a sleep cycle. The processing is performed to detect the optimal time to wake the individual such that the individual feels refreshed after sleeping as is known in the art. In addition to analyzing current sleep data, past sleep data (e.g., from previous nights) may additionally be included in the calculation of sleep quality feedback. Such historical data may be used to identify individual patterns in sleep, which may change if the individual is a heavy sleeper, light sleeper, or suffers from a sleep disorder. Processing the sleep cycle data preferably uses a learning algorithm to increase the effectiveness of the calculations for an individual. The base device is preferably devoted to more taxing tasks such as processing data, receiving user input for an alarm setting, and other features, which functions to allow the individual sleep device to have a minimal number of components such that individual sleep device can be designed for comfort and ergonomics while the individual sleeps. The base device preferably receives sleep data from the individual sleep device during Step S140. Processing of the sleep data may alternatively only be performed when approaching a set alarm time. The base device may additionally communicate with a central sleep service platform or some other data or processing service as shown in FIG. 7. The central sleep service platform preferably contains data from a plurality of users, and may additionally be used in the calculation of sleep quality feedback. For example, the central sleep service platform may be used to calculate how the quality of sleep of one user compares to other users of a similar demographic. The central sleep service platform may additionally provide additional processing capabilities, which are preferably communicated back to the base device.

Step S160, which includes activating an alarm, functions to wake an individual up with an alarm in a non jarring manner. The alarm is preferably a targeted alarm that won't disturb the sleep of other people asleep in the same vicinity. The alarm is preferably a vibrational alarm, but may alternatively be a temperature-based alarm, a targeted audio signal such as headphones worn like a hearing aid, or any suitable device capable of disturbing the sleep of an individual. The activation of an alarm may additionally initialize a sequence of alarm events. In a first variation, activating the targeted alarm preferably includes generating a random signal pattern for the targeted alarm. The signal is preferably converted to vibration, but may be any suitable output from the targeted alarm. The random signal pattern is preferably repeated within a single alarm, and the pattern between alarms is preferably different. In generating the random signal a poisson distribution is preferably utilized. Additionally, for a vibration signal the pauses are preferably of longer duration than the pulses. In second variation, the vibration (or any suitable targeted alarm) preferably ramps up the intensity of the vibration. An initial vibration preferably starts off light, and then proceeds to ramp up in short spurts of vibration to a high amplitude vibration. This vibrational pattern is preferably repeated after a few seconds with an incrementally stronger initial vibration. The intensity of the vibration is preferably controlled by pulsing a vibrational motor. In another variation, the vibrational motor may be activated for random lengths of time and intensities. This is preferably performed after a ramp up pattern to increase the likelihood of waking an individual. As anther variation, the vibration may be activated with a frequency envelope. The frequency envelope is preferably designed to emulate the pattern of human voice inflections. The vibrational patterns are preferably unique between sleeping periods. In other words the vibrational pattern is preferably unpredictable which functions to prevent an individual from building up a tolerance to an alarm. These variations or any suitable patterns may be used in any suitable combination. The alarm may be triggered as part of the sleep quality feedback in a variation where the sleep quality feedback is an optimized alarm time.

Step S170, which includes communicating sleep quality feedback to the user, functions to output feedback to the user. The communication is preferably directly communicated through a graphical display of the base device. The results summarizing a night of sleep is preferably produced for the user. The user can preferably use this graphical representation (e.g., graphs, textual descriptions, etc.) of measurable and physical properties experienced by the user during sleep to alter or modify sleep practices. The communication may alternatively be communicated through a physical alarm of the individual sleep alarm in Step S160. The sleep quality feedback may be an optimized time for waking a user. This calculated time is preferably communicated from the base device to the individual sleep device; the individual sleep device triggers the alarm based on the sleep quality feedback; and the alarm in turn transfers to the user through vibration or any suitable alarming technique.

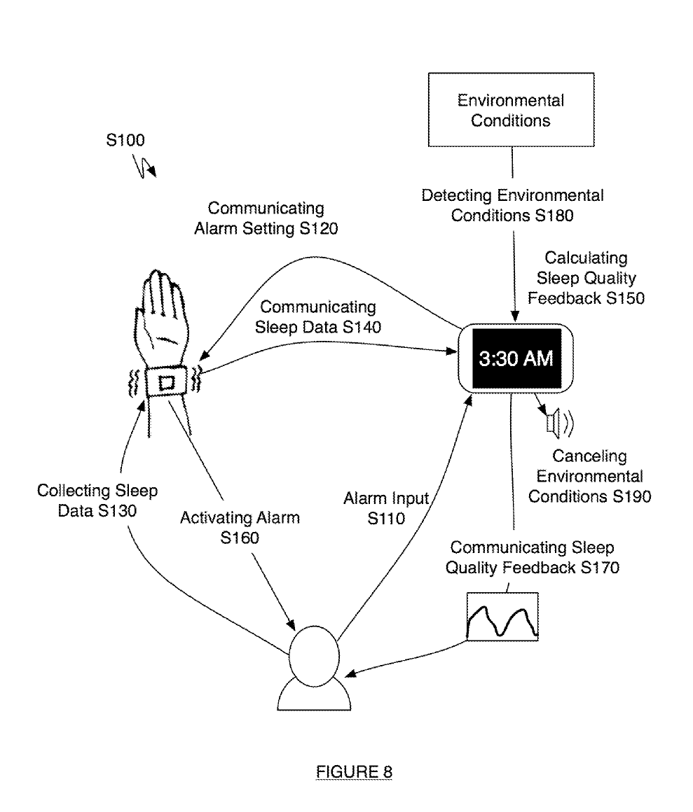

Additionally, the method may include detecting environmental conditions S180, and cancelling negative environmental conditions through an active output S190. The additional Steps S180 and S190 function to cooperatively mask any outside stimuli that may lower the quality of sleep of an individual as shown in FIG. 8. Step S180 preferably uses data collected in Step S130 and may additionally use data collected from the base device or any suitable device. Environmental data preferably includes recording background noise, but may additionally include sensing temperature levels, sensing light levels or sensing any suitable environmental parameter. The detection of environmental conditions is preferably achieved through sensors of the base device such as a light sensor, camera, microphone, or any suitable sensor. The environmental data is preferably recorded during the night and analyzed to detect patterns in sleep cycles and the environment. The method preferably includes measuring decibel levels and frequency, determining a threshold of sensitivity for the individual in sound at certain frequencies and other environmental conditions, and detecting patterns over multiple sleep periods. For example, a correlation may be detected between environmental noise and the quality of sleep of an individual. Such environmental processing can preferably be used as analytic feedback to an individual (e.g., learning how an environment adversely or positively impacts sleep), to schedule wakeup times (e.g., shifting a wakeup time to avoid a poor sleep cycle due to increasing environment noise), applying noise cancellation to block particular noises, and/or any suitable application of environmental data. Such environmental sleep analysis may additionally be used in dorms or boarding situations (such as in the military) to optimize pairings of bunkmates, roommates, or arrangement of sleepers.

The cancelling (or at least dampening) of negative environmental conditions is preferably achieved either through the base device, the individual sleep device, and/or an additional output source in communication with the base device and/or individual sleep device. Preferably, the base device produces audio either through base device speaker or through a connected speaker system. The individual sleep device may alternatively use the alarm (e.g., vibrational targeted alarm) as a way to stimulate the user with the goal of removing the negative environmental condition. In one example, the base device preferably monitors audio input to detect disruptive noises such as snoring, outside traffic noise, TV sounds, or any suitable source of sound. The base device then plays audio that masks the negative environmental noise. The audio is preferably a form of background noise that covers up or distracts the user from the negative sound. In another example, the user may be snoring, which is preferably detected from a microphone on the base device and/or by user activity input on the individual sleep device. The individual sleep device may vibrate to prompt the user to roll over or adjust sleeping position.

As a second application, the processing includes situational sleep planning. In this application, the sleep quality feedback may adjust alarm time and suggested time to go to bed. This application can preferably be used to plan sleep schedules for a particular situation. One such situation may include recovering from jetlag. The processing preferably assess the amount and quality of sleep while traveling, notifying a user when to fall asleep based on time zone changes. As another exemplary situation, an important date, such as an important exam, may be used to coordinate a sleeping pattern so that on that date the individual is well rested. Additionally, a personal calendar may be used for sleep schedule planning. This is particularly useful when time is short and an individual may have to use an irregular sleep schedule. This can additionally be used as an occupational safety system to ensure that the amount of rest of an individual does not adversely affect quality of work. This may be particularly useful for truck drivers, pilots, air traffic controllers, doctors, and any suitable professional.

As another application, the method may additionally be applied to the trading of sleep interruption between several individuals. This is particularly relevant to parents with a newborn child. The alarm preferably alternates waking of a parent when a baby requires care, feeding, or is crying. The waking of a parent is preferably timed according to a sleep cycle of a parent. The alarm may additionally not simply alternate, but assess quality of sleep for that night and previous nights, such that the overall quality of rest is maximized. For example, one parent may have more difficulty falling asleep after waking. The method would preferably wake the other parent to care for the baby more often in this example. The alarm may additionally compare sleep cycle stage and wake up the parent nearest an optimal time for waking. The baby may additionally wear a individual sleep device to measure sleep data. The baby device can preferably be used to detect the sleep data of a baby. The sleep data of the baby may be used to determine when the baby is about to wake up and coordinate the waking of a parent during an optimal sleep cycle stage. This may additionally be applicable to caregivers of elderly, pets, professionals responding to emergency calls, or any suitable situation that requires trading of sleep interruption.

An alternative embodiment preferably implements the above methods in a computer-readable medium storing computer-readable instructions. The instructions are preferably executed by computer-executable components preferably integrated with a base device and an individual sleep device. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for providing sleep quality feedback comprising:
receiving alarm input on a base device from a user;
communicating an alarm setting based on the alarm input from the base device to an individual sleep device;
collecting sleep data with the individual sleep device based on activity input of a user;
communicating sleep data from the individual sleep device to the base device;
calculating sleep quality feedback from the sleep data with the base device;
communicating sleep quality feedback to a user; and
activating an alarm by generating tactile feedback from the individual sleep device to the user according to the alarm setting.

2. The method of claim 1, wherein activating an alarm includes generating a random signal pattern that controls the generation of tactile feedback.

3. The method of claim 1, wherein communicating sleep feedback includes the base device displaying a graphical representation of the sleep quality feedback.

4. The method of claim 1, wherein calculating sleep quality feedback includes calculating an optimized alarm setting from the sleep data and the alarm input, and wherein communicating the alarm setting to the individual sleep device includes communicating the optimized alarm setting.

5. The method of claim 1, wherein communicating the alarm setting includes sending a command to activate the alarm.

6. The method of claim 1, wherein communicating the alarm setting includes setting a local alarm of the individual sleep device.

7. The method of claim 1, wherein collecting sleep data based on activity input includes sensing user movement.

8. The method of claim 7, wherein collecting sleep data based on physical activity input includes conditioning sensed user movement into a sleep quality datapoint for a duration of time.

9. The method of claim 8, wherein conditioning sensed user movement includes highpass filtering, low pass filtering, and performing a moving average on sensed user movement to generate a sleep quality datapoint for at least every 30 seconds, wherein the sleep data is composed of a plurality of sleep quality datapoints.

10. The method of claim 9 wherein calculating sleep quality feedback includes calculating conditioning parameters; and further comprising communicating the conditioning parameters to the individual sleep device, wherein conditioning sensed user movement uses the communicated conditioning parameters.

11. The method of claim 1, further comprising storing the sleep data on a remote shared computing resource; calculating at least a portion of the sleep quality feedback from a plurality of datasets on the shared computing resource; and communicating the portion of the sleep quality feedback to the base device.

12. The method of claim 11, wherein the plurality of datasets includes sleep data from a plurality of users.

13. The method of claim 1, further comprising the base device detecting environmental conditions; and canceling at least some of the environmental conditions through an active output.

14. The method of claim 13, wherein detecting environmental conditions includes retrieving audio input; and wherein the active output to cancel negative environmental conditions is an audio signal played through the base device that masks the retrieved audio input.

15. The method of claim 13, wherein the active output is a trigger to generate tactile feedback on the individual sleep device.

16. The method of claim 1, further comprising receiving a change of sleep schedule input from the user; calculating an alarm transition schedule based on the sleep schedule input and a history of sleep data; and adjusting the alarm setting according to the calculated transition schedule.

17. The method of claim 1, further comprising:
receiving second alarm input on a base device for a user of a second individual sleep device;
communicating an alarm setting based on the second alarm input from the base device to the second individual sleep device;
collecting sleep data with the second individual sleep device based on activity input of a user;
communicating sleep data from the second individual sleep device to the base device;
calculating sleep quality feedback for the user of the second individual sleep device from the sleep data with the base device;
communicating sleep quality feedback for the sleep data collected on the second individual sleep device; and
activating an alarm by generating tactile feedback from the second individual sleep device to the user according to the alarm setting.

18. A system for providing sleep quality feedback comprising:
an individual sleep device that includes a sleep pattern sensor that collects sleep data of a user, a targeted alarm, and a wireless communication component; and
a base device that includes an alarm input component, a sleep data analysis engine to calculate sleep quality feedback to the user, and a wireless communication component with at least a temporary communication connection to the wireless communication component of the base device.

19. The system of claim 18, further comprising a central sleep service platform including a database of sleep data for a plurality of users and a network connection to the base device.

20. The system of claim 18, wherein the targeted alarm is a vibrational alarm coupled to a user through a housing of the individual sleep device; wherein the sleep pattern sensor includes a conditioning engine including a highpass filter, a lowpass filter and a moving average filter, where the output of the conditioning engine is connected to the wireless communication component.
